(19) United States
(12) Patent Application Publication
(10) Pub. No.: US 2017/0027117 A1
(43) Pub. Date: Feb. 2, 2017

(54) FLOWABLE HYDROGELS FOR BOTANICAL APPLICATIONS

(71) Applicants: Edward Parsonage, St. Paul, MN (US); Benjamin Parsonage, St. Paul, MN (US)

(72) Inventors: Edward Parsonage, St. Paul, MN (US); Benjamin Parsonage, St. Paul, MN (US)

(21) Appl. No.: 15/213,195

(22) Filed: Jul. 18, 2016

Related U.S. Application Data
(60) Provisional application No. 62/282,042, filed on Jul. 23, 2015.

(51) Int. Cl. A01G 31/00; A01G 1/00

(52) U.S. Cl. CPC A01G 31/001; A01G 1/001

(57) ABSTRACT

The present disclosure is directed to a method for providing a flow-able hydrogel for germinating, cultivating, transporting or displaying plants. The method generally includes at least three distinct steps: 1) dissolving a polyethylene glycol having functionalized end-groups in water to form a flow-able solution, 2) dissolving one or more activating agents within the flow-able solution such that the activating agents react with the functionalized end-groups of the polyethylene glycol to form a non-flow-able hydrogel after a set-time, 3) pouring the flow-able solution into a container prior to the set time such that the flow-able solution assumes the shape of the container and forms a non-flow-able hydrogel.

### FIELD

This disclosure in general relates to a method for germinating, cultivating, transporting and displaying plants. The disclosure specifically relates to a method for providing a flow-able hydrogel including at least three distinct steps: 1) dissolving a polyethylene glycol having functionalized end-groups in water to form a flow-able solution, 2) dissolving one or more activating agents within the flow-able solution such that the activating agents react with the functionalized end-groups of the polyethylene glycol to form a non-flow-able hydrogel after a set-time, 3) pouring the flow-able solution into a container prior to the set time such that the flow-able solution assumes the shape of the container and forms a non-flow-able hydrogel.

### BACKGROUND

The use of hydrogels as soil amendments and coatings for horticultural and agricultural applications are well known. A summary of the current is provided in “Functionalized Polymeric Materials in Agriculture and the Food Industry” by Ahmed Akelah, Springer, 2013.

Examples of commercially available products include cross-linked polyacrylamide particles such as SoilMoist™ and Watersorb∩. U.S. Pat. No. 5,382,270 describes a method for plant growing utilizing discrete particles of polyethylene glycol hydrogel cross-linked with a multi-functional isocyanate. The invention described in U.S. Pat. No. 5,382,270 differs from the current disclosure in that the polyethylene glycol is pre-crosslinked to an insoluble particulate state prior to transferring to the desired container. Furthermore the polyethylene glycol of U.S. Pat. No. 5,382,270 is not “functionalized” as defined herein. U.S. Pat. No. 5,185,024 describes the application of insoluble polyacrylamide and poly(ammonium acrylate) hydrogels to agricultural soils or crops by spraying. United States patent application 2007/0044528A1 describes a soil amendment comprising a pump-able liquid formed from cross-linked polymer particles and a liquid fertilizer. The method disclosed herein differs from 2007/0044528A1 in that the flow-able solution is first poured as an un-crosslinked solution and does not comprise distinct particles of hydrogel. U.S. Pat. No. 5,557, 882 discloses a method for coating embryonic plants with a hydrogel by first applying a dry powder of a polymer, swelling of the applied powder with water, followed by exposure of the ionic crosslinking agent. U.S. Pat. No. 6,557,298 B2 generally discloses coating of seeds with a dry hydrogel forming polymer plus an active ingredient. U.S. Pat. No. 8,143,333 describes a method for germinating, growing or cultivating plants through the addition of a cross-linked, spongy, porous polymer and also contain at least 30% of a mineral nutrient by dry weight. U.S. Pat. No. 8,993,735 B2 discloses a substrate for soil improvement with water storing properties comprising a diglycidyl ether epoxide crosslinking of a chemically modified lignin resulting in ethylene oxide crosslink composition. Patent application WO2014029029 A1 discloses a method for reducing or preventing topsoil erosion using hydrogel solution mixtures of polyacrylic acid and a poly glycol other than polyethylene glycol.

However current hydrogel compositions for botanical applications generally suffer from being in an insoluble, pre-solidified form. For example, as an insoluble particulate it is difficult to mix the solid chunks intimately within soil, particularly with previously potted plants wherein application at root level is desired. Furthermore the subsequent swelling of the hydrogel particles after hydration can crack the soil resulting in accelerated water loss. Addition of non-cross-linked polymer solutions to soil generally suffer from more rapid water loss in comparison to cross-linked hydrogels. In other applications such as seed starting or plant display it is desirable to have a continuous hydrogel which assumes the shape of the container being used. This is generally not practical for non-flow-able solutions especially in cases where the amendment is required to permeate through soil.

An advantage of the disclosure herein is that the hydrogel is initially in a flow-able liquid form allowing deep and intimate penetration of the soil. Another advantage of the disclosure herein is that the liquid hydrogel may be poured to assume the shape of a container for, as examples, starting seeds, cultivating, transporting and displaying plants.

### SUMMARY

The present disclosure is directed to a unique method for germinating, cultivating, transporting and displaying plants. The method generally includes at least three distinct steps: 1) dissolving a polyethylene glycol having functionalized end-groups in water to form a flow-able solution, 2) dissolving one or more activating agents within the flow-able solution such that the activating agents react with the functionalized end-groups of the polyethylene glycol to form a non-flow-able hydrogel after a set-time, 3) pouring the flow-able solution into a container prior to the set time such that the flow-able solution assumes the shape of the container and forms a non-flow-able hydrogel.

An embodiment of the method includes steps having an acrylic functionalized polyethylene glycol, a peroxide activating agent, and a container comprising a potted plant.

In another embodiment the one or more activating agents includes a redox coupling agent.

In another embodiment the one or more activating agents includes a plant nutrient.

In another embodiment the one or more activating agents includes a fungicide.

In another embodiment the one or more activating agents includes a colorant.

In another embodiment the one or more activating agents are first dissolved in water followed by addition of the functionalized polyethylene glycol.

Another embodiment of the method includes steps having a container comprising a vessel for hydroponic aquaculture.

In another embodiment the container is a vessel for seed starting.

In another embodiment the container is a vessel for propagating mature plants.

In another embodiment, the container is a vessel for displaying plants.

In another embodiment the container is a vessel for transporting plants.

In another embodiment the container is a vessel for cultivating mushrooms.

In another embodiment the hydrogel solution is sprayed onto the walls of a container.

### BRIEF DESCRIPTION OF THE DRAWINGS

FIG. 1 is a schematic perspective view of the disclosed method wherein functionalized polyethylene glycol PEG-X and activating agents Y, Z are added to water to form a flow-able solution which is then poured into a container C containing a plant potted in soil S to form a final non-flow-able hydrogel H.

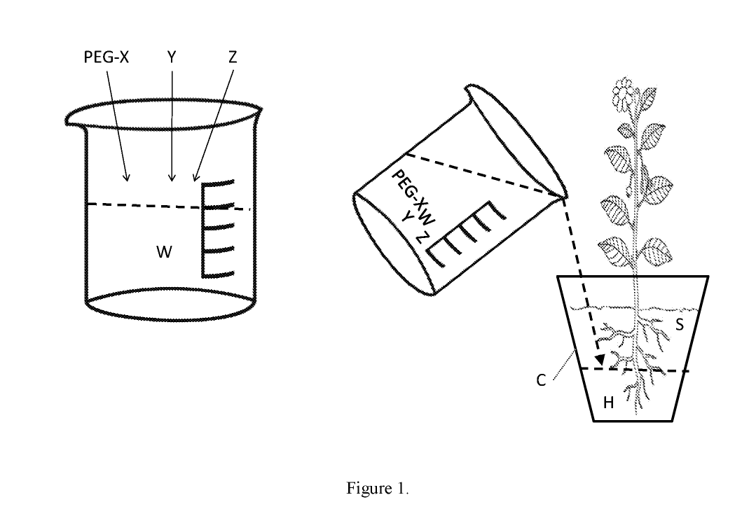

### DETAILED DESCRIPTION OF THE EMBODIMENTS

As noted above, the embodiments are directed to a method for germinating, cultivating, transporting and displaying plants. The method generally includes at least three distinct steps: 1) dissolving a polyethylene glycol having functionalized end-groups in water to form a flow-able solution, 2) dissolving one or more activating agents within the flow-able solution such that the activating agents react with the functionalized end-groups of the polyethylene glycol to form a non-flow-able hydrogel after a set-time, 3) pouring the flow-able solution into a container prior to the set time such that the flow-able solution assumes the shape of the container and forms a non-flow-able hydrogel.

As defined herein, “functionalized polyethylene glycols” are oligomeric or polymeric molecules comprising polyethylene glycol having reactive functional units as the end-groups of the chain. The functionalized polyethylene glycol may be linear or branched. The functionalized polyethylene glycol has the general structure:

—(CH2CH2O)ₙ—CH2CH2O—X

Wherein the functional group X is attached to the terminal end of a polyethylene glycol branch with degree of polymerization n+1.

The functionalized PEG will in general have a distribution of molecular weights. The average molecular weight is preferably between 200 g/mol and 20,000 g/mol and more preferably between 400 g/mol and 2000 g/mol.

Although initially in a flow-able state, the functional groups of the polyethylene glycol react with the activation agents to form a cross-linked hydrogel over time. Functional groups my include, for example, groups with reactive carbon-carbon double bonds such as vinyls, allyls, acrylates, methacrylates, maleimides and vinyl sulfones. Functional groups may also include reactive groups susceptible to nucleophilic substitution such as epoxides, tosylates, succinimide esters, isocyanates and halogens. Functional groups may further include bases and salts of bases such as amines and carbonates, acids and salts of acids such as carboxylates, sulfates, phosphates and thiols. Specific functionalized polyethylene glycols include, for example, PEG-acrylate, PEG-methacrylate, PEG-NETS, PEG-thiol, PEG-tosylate, PEG-bromide, PEG-iodide, PEG-chloride, PEG-NH2, PEG-epoxide, PEG-isocyanate, PEG-isothiocyanate, PEG-aldehyde, PEG-carboxylate, PEG-hydrazide, PEG-maleimide, PEG-azide and PEG-silane. PEG diacrylate is a preferred functionalized PEG. Preferably there are one or more functional groups per PEG chain. More preferred are di-functional linear PEGs with the functional group located at each end group of the linear PEG polymer.

As defined herein, “activating agents” include molecules which react with the functional groups on the polyethylene glycol to form a cross-linked network. Examples of activating agents include water soluble free radical initiators such as water soluble peroxides and azo compounds. In principle the initiators used are those whose solubility in water is so great that the amount of initiator used is completely dissolved within the respective reaction medium. Preferred polymerization initiators include water-soluble azo compounds, such as 2,2′-azobis[2-(2-imidazolin-2-yl)propane, 2,2′-azobis(2-amidinopropane) and their acid addition salts, especially the hydrochlorides, acetates or (hydrogen)sulfates, 4,4′-azobis(4-cyanovaleric acid) and the alkali metal or ammonium salts thereof, especially the sodium salts, or 2-(carbamoylazo)isobutyronitrile. They further include water-soluble peroxides and hydroperoxides, such as tert-butyl hydroperoxide, tert-amyl hydroperoxide, cumene hydroperoxide, pinane hydroperoxide, peroxodisulfuric acid and its salts, especially its alkali metal or ammonium salts, and hydrogen peroxide. These peroxides and hydroperoxides can be employed alone or, preferably, together with a reducing agent, such as a salt of hydroxymethanesulfinic or ascorbic acid, or a transition metal compound which is able in aqueous solution to exist in various oxidation states, examples being iron(II) salts or copper(II) salts (known as redox initiator systems). A preferred free radical initiator is potassium persulfate in combination with ascorbic acid. Activating agents may be any other compound capable of reacting with the functionalized polyethylene glycol to form a cross-linked network. These would include, for example, multifunctional amines such as polythylene imine, multifunctional thiols, multifunctional epoxides, multifunctional vinyl and allyl compounds such as triallyl isocyanurate, multifunctional alkoxides and silanes, to name a few. In general the activating agents will be present in amounts from 0.1% to 10%, more preferably 1% to 5%.

As defined herein “colorants” are generally un-reactive biocompatible compounds to provide a desired appearance of the mixed hydrogel. Examples of colorants may be selected from any combinations of FD&C Blue #1, FD&C Blue #2, FD&C Green #3, FD&C Red #3, FD&C Red #40 , FD&C Yellow #5, and FD&C Yellow #6. The colorant will be present in relatively low amounts of 0.001%-2% and more preferably 0.01%-1%.

As defined herein “fungicides” are known biocompatible compounds commonly used for mold prevention. Fungicides can be selected from many synthetic or natural compounds. Natural fungicides are derived from natural oils and include tea tree and grapefruit extract, Aloe, Amole Lily (scalp), Ash, Balsamroot, Calendula, California Bay Laurel, California Bayberry, California Mugwort, Camphorweed, Candidiasis, Chaparral, Cypress, Desert Willow, Echinacea, Epazote, Eucalyptus (upper GI), Labrador Tea, Oregon Grape, Oxeye Daisy, Red Cedar, Stillingia, Sweet Root, Trumpet Creeper, White Sage, and Yerba Mansa. Suitable synthetic fungicides can be selected from the following groups: aliphatic nitrogen compounds such as including butylamine, cymoxanil, dodicin, dodine, and guazatine. Amide fungicides including, carpropamid, chloraniformethan, cyazofamid, cyflufenamid, diclocymet, ethaboxam, fenoxanil, flumetover, furametpyr, prochloraz, quinazamid, silthiofam, and triforine. Acylamino acid fungicides including benalaxyl, benalaxyl-M, furalaxyl, metalaxyl, metalaxyl-M, pefurazoate; benzamide fungicides such as benzohydroxamic acid, tioxymid, trichlamide, zarilamid and zoxamide; furamide fungicides such as, cyclafuramid and furmecyclox; phenylsulfamide fungicides such as dichlofluanid, tolylfluanid; valinamide fungicides such as benthiavalicarb, iprovalicarb; anilide fungicides such as benalaxyl, benalaxyl-M, boscalid, carboxin, fenhexamid, metalaxyl, metalaxyl-M, metsulfovax, ofurace, oxadixyl, oxycarboxin, pyracarbolid, thifluzamide, tiadinil; benzanilide fungicides such as benodanil, flutolanil, mebenil, mepronil, salicylanilide, tecloftalam; furanilide fungicides such as fenfuram, furalaxyl, furcarbanil, methfuroxam, and sulfonanilide fungicides such as flusulfamide. Antibiotics including aureofungin, blasticidin-S, cycloheximide, griseofulvin, kasugamycin, natamycin, polyoxins, polyoxorim, streptomycin, validamycin; strobilurin fungicides such as azoxystrobin, dimoxystrobin, fluoxastrobin, kresoxim-methyl, metominostrobin, orysastrobin, picoxystrobin, pyraclostrobin and trifloxystrobin. Aromatic fungicides including biphenyl, chlorodinitronaphthalene, chloroneb, chlorothalonil, cresol, dicloran, hexachlorobenzene, pentachlorophenol, quintozene, sodium pentachlorophenoxide, and tecnazene. Benzimidazoles including benomyl, carbendazim, chlorfenazole, cypendazole, debacarb, fuberidazole, mecarbinzid, rabenzazole, and thiabendazole. Carbamates including benthiavalicarb, furophanate, iprovalicarb, propamocarb, thiophanate, thiophanate-methyl; benzimidazolylcarbamate fungicides such as benomyl, carbendazim, cypendazole, debacarb, mecarbinzid; and carbanilate fungicides such as diethofencarb. Copper based fungicides including bordeaux mixture, burgundy mixture, chestnut mixture, copper acetate, copper carbonate, basic, copper hydroxide, copper naphthenate, copper oleate, copper oxychloride, copper sulfate, copper sulfate, basic, copper zinc, cromate, cufraneb, cuprobam, cuprous oxide, mancopper, and oxine copper. Dicarboximides including famoxadone, fluoroimide, dichlorophenyl dicarboximide fungicides such as chlozolinate, dichlozoline, iprodione, isovaledione, myclozolin, procymidone, vinclozolin; phthalimide fungicides such as, captafol, captan, ditalimfos, folpet, and thiochlorfenphim. Imidazoles including cyazofamid, fenamidone, fenapanil, glyodin, iprodione, isovaledione, pefurazoate, and triazoxide. Inorganic fungicides including potassium azide, potassium thiocyanate, sodium azide, and sulfur. Organophosphorous compounds including ampropylfos, ditalimfos, edifenphos, fosetyl, hexylthiofos, iprobenfos, phosdiphen, pyrazophos, tolclofos-methyl, and triamiphos. Ureas such as bentaluron, pencycuron, and quinazamid. The fungicide will be present in relatively low amounts of 0.001%-2% and more preferably 0.01%-1%. Water soluble copper fungicides are preferred.

As defined herein, germinating, cultivating, transporting or displaying plants includes soil and hydroponic based seed starting and propagation of mature plants, agricultural production, shipment of seeds or germinated plants, or any manner of displaying plants for personal or commercial use.

The functionalized PEG and activating agents may be mixed in any order to form the flow-able hydrogel. Mixing of the components may be achieved by any number of ways including, for example, adding to a container of defined volume in combination with mechanical stirring, shaking, and ultrasound vibration, to name a few. Mixing may also include addition of the components at the desired ratios in a continuous flow process to produce the desired hydrogel composition.

“Pouring” of the flow-able hydrogel is defined as any process used to transfer the flow-able solution from the mixing step to the final desired container. This may include, for example, simply pouring by hand, mechanical transfer by means of a pump, and spraying.

As defined herein “containers” are any desired vessel or space into or onto which the initial flow-able solution is to be poured. Such containers may include, for example, a pot holding a previously potted plant, containers for seed starting, containers for propagation, vessels for hydroponic growth, a container for displaying plants, and a container or bag for shipping plants. The container may also include spraying onto just the surface of a vessel to contain a plant. The container may also be defined as a larger plot of soil such as a plant bed, garden or field. The container may also be the surface of a seed or the exposed leaves, stems, trunk and roots of a plant.

The hydrogel solution may have a range of percent solids optimized to the desired application. The percent solids is defined as the ratio of the volume of functionalized polyethylene glycol to the volume of water Useful ranges of percent solids range from 0.5% to 20%, more preferably 1% to 10%, and more preferably 3% to 7%.

The flow-able hydrogel will also have a range of set times depending on the intended use. The set time is defined as the time at which the hydrogel is no longer flow-able. Flow-able here is defined as the property of extending indefinitely under an applied shear stress. Similarly, non-flow-able is defined as the ability to support a shear stress without deforming indefinitely. The set-time will generally correspond to the gel-point of the reacting hydrogel solution, wherein the gel-point is defined as the time wherein the cross-linking has produced a single branched molecule which spans the container into which the flow-able solution has been poured. Useful ranges of set times range from 0.01 minutes to 120 minutes. A preferably range for pouring of the hydrogel is 10 minutes to 120 minutes, more preferably 30 minutes to 60 minutes. A preferably range for spraying is 0.01 minutes to 1 minute, more preferably 0.015 minutes to 0.03 minutes.

### EXAMPLE 1

In this example, activating agents comprising 2.5 grams of potassium persulfate plus 2.5 grams of ascorbic acid plus 2.5 grams of MircaleGro were added first to 16 ounces of water. After dissolution of these components 25 mL of a 700 molecular weight PEG diacrylate was added to form the flow-able solution. After approximately 5 minutes 80.1 grams of flow-able hydrogel was then added to 37.1 g of dry potting soil in a Styrofoam cup container such that the flow-able solution permeated to the bottom of the container and formed a non-flow-able hydrogel solution after approximately 30 minutes. The final composition comprising the soil and non-flow-able hydrogel solution was allowed to dry under ambient conditions, and the weight of the hydrogel plus soil was monitored using a calibrated balance. The potting soil plus hydrogel returned to the original dry weight of 37.1 grams in 27 days.

### COMPARATIVE EXAMPLE 2

In Comparative Example 2, 82.5 grams of water was added to 37.3 grams of potting soil. The wetted potting soil plus water lost 80 grams of water after 22 days.

### COMPARATIVE EXAMPLE 3

In Comparative Example 3, 98.8 grams of water was added to 39.7 grams of dry potting soil plus 4 grams of SoilMoist™ polyacrylamide hydrogel particles for a total dry weight of 43.7 grams. The wetted potting soil plus SoilMoist™ lost 80 grams of water after 19 days.

The greater than 5 days required to lose the same amount of water demonstrates the improvement in water retention attained using the method of this disclosure.

We claim:

1. A method for botanical application comprising:
a) dissolving a polyethylene glycol having functionalized end-groups in water to form a flowable solution,
b) dissolving one or more activating agents in the flowable solution such that the activating agents react with the functionalized end-groups of the polyethylene glycol to form a non-flowable hydrogel after a set-time,
c) pouring the flowable solution into a container prior to the set time such that the flowable solution assumes the shape of the container and forms a non-flowable hydrogel.

2. The method of claim 1, wherein the polyethylene glycol has functional groups selected from the group consisting of an acrylate, an epoxide, a succinimide ester, a tosylate and a thiol.

3. The method of claim 1, wherein the activating agent is selected from the group consisting of a peroxide, an amine, a vinyl, ascorbic acid and an iron salt.

4. The method of claim 1, wherein the activating agents further comprises a nutrient selected from the group consisting of an amine and a phosphate.

5. The method of claim 1, wherein the activating agents further comprises a colorant.

6. The method of claim 1, wherein the activating agents further comprises an anti-microbial.

7. The method of claim 1 wherein the activating agents are first dissolved in water followed by addition of the polyethylene glycol.

8. A method for botanical application comprising:
a) dissolving a polyethylene glycol having functionalized end-groups in water to form a flowable solution,
b) dissolving one or more activating agents in the flowable solution such that the activating agents react with the functionalized end-groups of the polyethylene glycol to form a non-flowable hydrogel after a set-time,
c) pouring the flowable solution into a container prior to the set time such that the flowable solution assumes the shape of the container and forms a non-flowable hydrogel

9. The method of claim 8, wherein the polyethylene glycol has functional groups selected from the group consisting of an acrylate, an epoxide, a succinimide ester, a tosylate and a thiol.

10. The method of claim 8, wherein the activating agent is selected from the group consisting of comprising a peroxide, an amine, a vinyl, ascorbic acid and an iron salt.

11. The method of claim 8, wherein the activating agents further comprises a nutrient selected from the group consisting of an amine and a phosphate.

12. The method of claim 8, wherein the activating agents further comprises a colorant.

13. The method of claim 8, wherein the activating agents further comprises an anti-microbial.

14. The method of claim 8 wherein the activating agents are first dissolved in water followed by addition of the polyethylene glycol.

15. A kit for botanical application comprising:
a) a polyethylene glycol having functionalized end-groups; and
b) one or more activating agents;
wherein the polyethylene glycol is dissolved in water to form a flowable solution and the one or more activating agent second agent are added to the flowable solution and the flowable solution is poured into a container to form a non-flowable solution after a set time.

16. The kit of claim 15, wherein the polyethylene glycol has functional groups selected from the group consisting of an acrylate, an epoxide, a succinimide ester, a tosylate and a thiol.

17. The kit of claim 15, wherein the activating agent is selected from the group consisting of a peroxide, an amine, a vinyl, ascorbic acid and an iron salt.

18. The kit of claim 15, wherein the activating agents further comprises a nutrient selected from the group the group consisting of an amine and a phosphate.

19. The kit of claim 15, wherein the activating agents further comprises an anti-microbial.

20. The kit of claim 15 wherein the activating agents are first dissolved in water followed by addition of the polyethylene glycol.
